(19) United States
(12) Patent Application Publication
(10) Pub. No.: US 2020/0189050 A1
(43) Pub. Date: Jun. 18, 2020

(54) ANCHOR BAR FOR WORK SURFACE TOOLS

(71) Applicant: D. Keith Bow, Corfu, NY (US)

(72) Inventor: D. Keith Bow, Corfu, NY (US)

(21) Appl. No.: 16/712,002

(22) Filed: Dec. 12, 2019

Related U.S. Application Data
(60) Provisional application No. 62/778,395, filed on Dec. 12, 2018.

(51) Int. Cl. B23Q 1/26

(52) U.S. Cl. CPC B23Q 1/26

(57) ABSTRACT

An improved anchor bar for isolating an adjustment force applied to the bar to result in an expansion force directed primarily outward to the sides of the anchor bar and to improve frictional contact with a work surface groove or slot.

This application claims priority under 35 U.S.C. § 119(e), from U.S. Provisional Patent Application No. 62/778,395 for an ANCHOR BAR FOR WORK SURFACE TOOLS, filed Dec. 12, 2018, by inventor D. Keith Bow, which is hereby incorporated by reference in its entirety.

The disclosed embodiments generally relate to an anchoring device for use with or by tools and aids used in woodworking. The anchor bar embodiments include a longitudinal bar that is attached to a tool and is used to engage a slot or groove in a work surface. The improvements to conventional anchor bars allow for improved translation of a tightening or locking force to a frictional coupling between the sides of the anchor bar and the slot or groove.

### BACKGROUND AND SUMMARY

As illustrated in the prior art of FIGS. 15A-15C, there is a representation of Applicant's prior anchor bar configuration, as well as a typical use of such an anchor bar in use with a FEATHERPRO™ product made by Bow Products. In anchor bars that are known, a conical screw head (e.g., FIG. 15C, bottom) is drawn into contact with a conical recess and associated hole in the anchor bar (e.g., FIG. 15C, top). As the screw is tightened by an adjustable knob, the conical screw head is forced into contact with the conical surface of the anchor bar. Doing so ultimately causes the expansion of the anchor bar about the hole, but only after the resistive radial forces applied by the conical recess to the screw head are overcome. In some configurations, the resistive forces may be significant because the contacting surface area between the screw head and the recess in the bar are significant, and there is no flexibility in the bar along its longitudinal axis and reduced flexibility along the transverse axis. These factors contribute to the poor performance of conventional anchor bars, including limited gripping force relative to a work-surface groove or slot, excessive tightening, potential for loosening of the anchor bar, etc.

In order to overcome the drawbacks of conventional anchor bar adjustment mechanisms, the anchor bar embodiments disclosed serve to better focus or concentrate the force created between the anchor bar and a grove into which it is placed, by adjusting (e.g., tightening) an adjustment member. More specifically, the configuration of the combination between the adjustment member, and the saddle or aperture in which the adjustment member operates, creates primarily outward-directed forces by tightening the adjustment member. The force is further concentrated due to the non-planar outer surfaces on several of the disclosed embodiments. Thus, as the adjustment member is tightened the force created is translated into outward forces pushing the sides of the anchor bar outward into contact with a groove, T-slot, etc.

Disclosed in embodiments herein is an anchor bar for releasably mounting a work tool on a work surface having a groove therein, comprising: a longitudinal bar having a generally rectangular cross-section with opposing sides as well as opposing upper and lower surfaces, the width of the longitudinal bar being just slightly narrower than an interior width of the groove so that the bar can be placed into and slide within the groove in a relaxed state, said bar including at least one region thereof with a vertical slit separating the sides from one another along the at least one region to allow the outward expansion of sides only, and at least one vertical aperture therethrough; and an adjustable member having a head at one end of a shaft, said head having a tapered profile on at least opposing sides thereof, said adjustable member being suitable for insertion through the at least one vertical aperture, such that the tapered profile aligns with opposed interior features of the vertical aperture in order for the tapered profile on opposite sides of the head to contact the opposed interior features of the aperture and cause, in response to an upward force being applied to the adjustable member, the outward expansion of sides only so as to produce frictional interference between the opposing sides of the bar and the interior of the groove.

Also disclosed in accordance with another embodiment is an anchor bar assembly for releasably mounting a work tool on a work surface having a groove therein, comprising: a longitudinal bar having at least one longitudinal slot therein, said slot splitting the bar into two attached but opposing sides, the bar also having an outer surface for frictional contact with the groove, the bar further including an internal saddle between the opposing sides the saddle including a generally rectangular recess and a vertical aperture therein, and where opposite sides of the saddle include opposing tapered surfaces; an adjustable member having a head at one end of a shaft, said head having a tapered profile on at least opposing sides thereof, said adjustable member being suitable for insertion through the vertical aperture, such that the tapered profile aligns with the opposing tapered surfaces of the saddle in order for the tapered profile on opposite sides of the head to contact the opposing tapered surfaces to cause, in response to a force applied to the adjustable member, an outward expansion of sides only so as to produce frictional interference between the opposing sides of the bar and the groove; and a force applicator, removably attached to the adjustable member, creating a force to draw the head of the adjustable member into contact with the tapered surfaces of the saddle.

### BRIEF DESCRIPTION OF THE DRAWINGS

FIGS. 1A-1C are, respectively, side, top and bottom perspective views of an anchor bar in accordance with a disclosed embodiment;

FIG. 2 is an illustration of an embodiment of the anchor bar attached to an exemplary featherboard;

FIGS. 3A-3C are, respectively, side, top and bottom perspective views of an alternative anchor bar in accordance with a disclosed embodiment;

FIGS. 4A-4C are, respectively, side, top and bottom perspective views of another alternative anchor bar configuration in accordance with a disclosed embodiment;

FIGS. 5A-5C are, respectively, side, top and bottom perspective views of an alternative anchor bar configuration in accordance with a disclosed embodiment;

FIGS. 6-8 are illustrative examples of the disclosed anchor bars in use with a featherboard;

FIGS. 9A-9F and 10A-10F are engineering drawings depicting alternative embodiments of anchor bars;

FIGS. 11A-11D are illustrations of alternative embodiments for an adjustment screw for use with one or more of the disclosed anchor bars;

FIGS. 12A-12B are illustrative examples of one embodiment of the anchor bar in use with a tool;

FIG. 13 is an illustration of the half-bar embodiment of the anchor bar attached for use with a featherboard;

FIG. 14 is an illustration of an adjustable cam member and applicator for applying an upward force to the adjustable member of the anchor bar; and

FIGS. 15A-15C are illustrative examples of prior art anchor bars.

The various embodiments described herein are not intended to limit the disclosure to those embodiments described. On the contrary, the intent is to cover all alternatives, modifications, and equivalents as may be included within the spirit and scope of the various embodiments and equivalents set forth. For a general understanding, reference is made to the drawings. In the drawings, like references have been used throughout to designate identical or similar elements. It is also noted that the drawings may not have been drawn to scale and that certain regions may have been purposely drawn disproportionately so that the features and aspects could be properly depicted.

### DETAILED DESCRIPTION

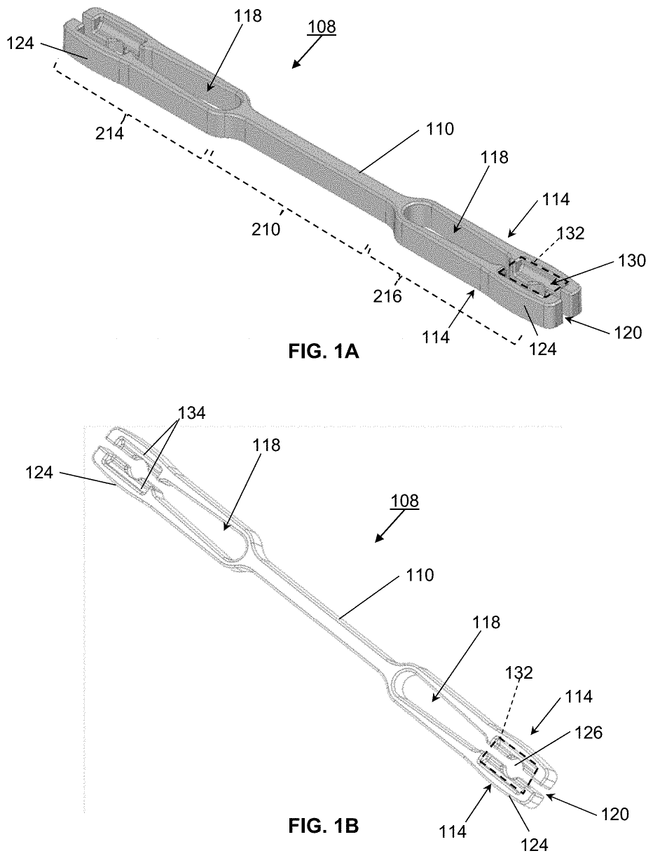

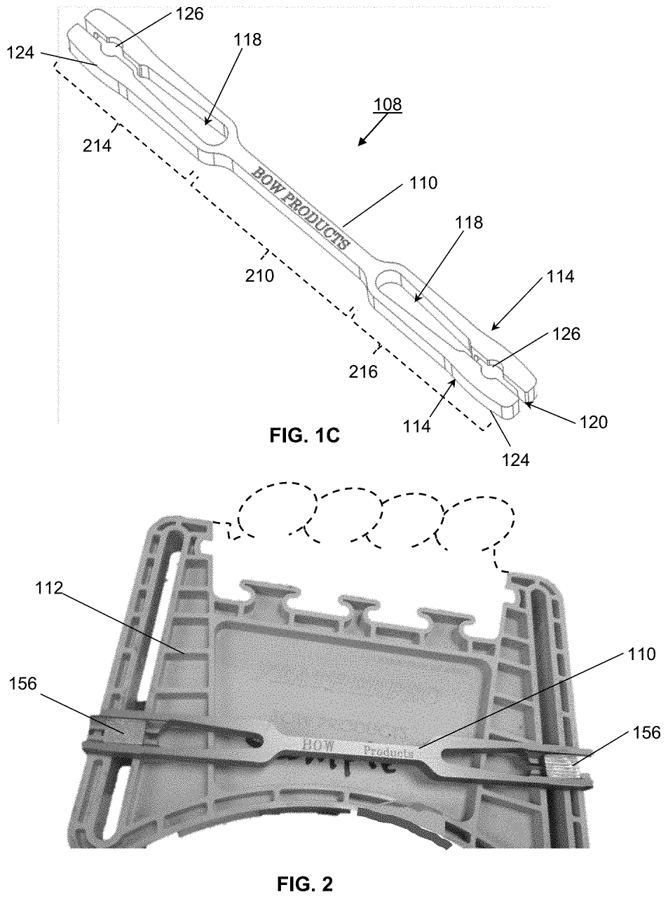

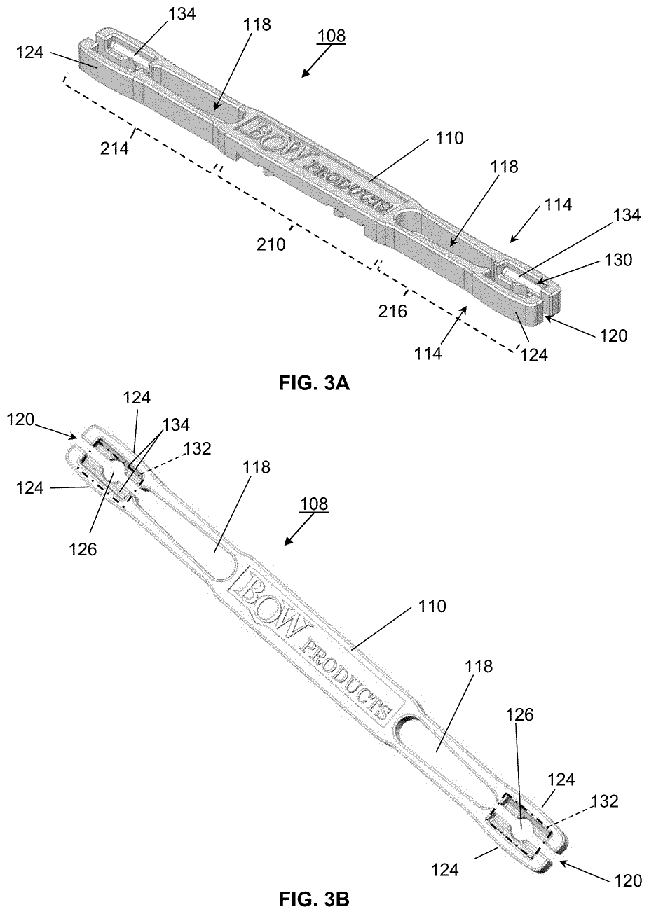

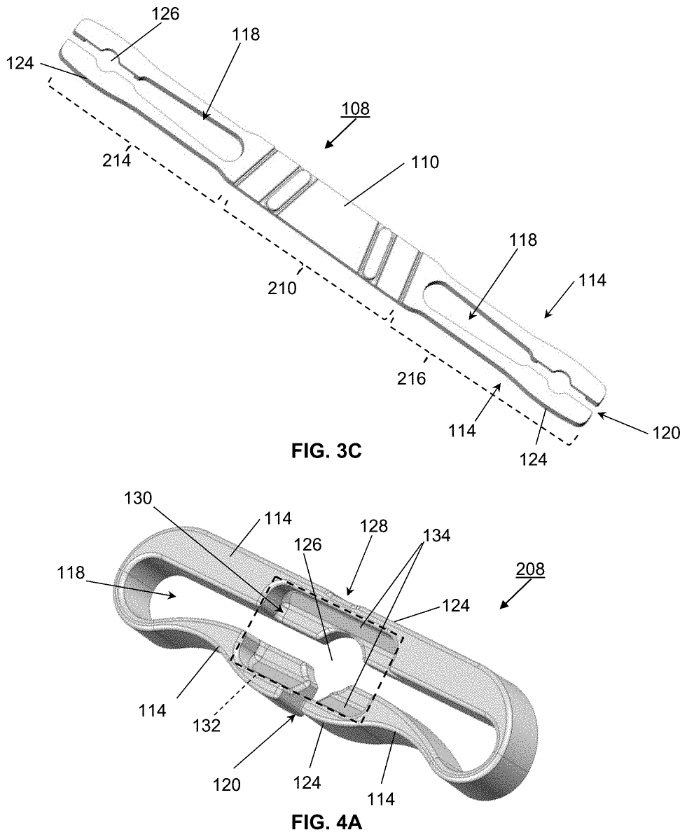

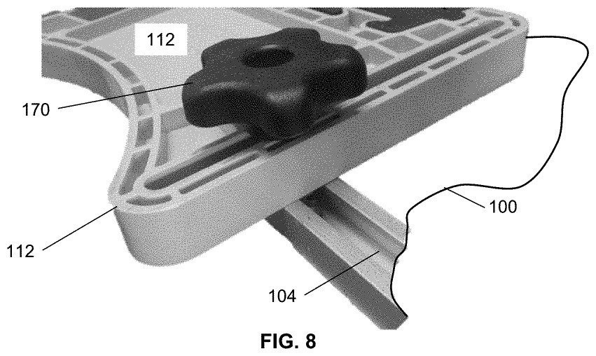

Referring to the drawings of FIGS. 1A-1C, depicted therein is one embodiment of an anchor bar 108. FIG. 1A illustrates a side perspective view while FIGS. 1B and 1C illustrate top and bottom perspective views. The anchor bar depicted includes three sections, an elongated, solid middle section 210 separating the ends 214 and 216. The ends of the anchor bar are sized so as to slip within a groove or a T-slot, both having a rectangular cross section, found in conventional work tables and fences on woodworking equipment (see e.g., FIG. 8). Each end (214, 216) of the anchor bar has a longitudinal slot 118 terminating in a vertical end slit 120, which splits each end of bar 108 into two attached but opposing sides. The bar 108 also has an outer surface 124 for frictional contact with the walls of the groove or T-slot. And, each of the alternative embodiments set forth in FIGS. 1A-1C, and 3A-3C, include a slight, lengthwise arc or radius in the outer wall surface (e.g., 124), making the surface non-planar. The slight arc assures that the contact between the outer wall of the anchor bar and the inner wall of the table groove is a concentrated contact—meaning the contact is over a limited area (e.g., a vertical line) as opposed to spread over a large surface along the entire wall. By doing so, the majority of the force applied by the anchor bar sides 114, against the walls of a groove, is concentrated and improved frictional contact is achieved.

To facilitate placing the bar into an anchored state, the bar further includes an internal saddle 130 between the opposing sides. The saddle is delineated or defined by a generally rectangular recess 132 spanning the opposing sides 114 and slot 118, and has a vertical aperture 126 therein. Within the saddle 130, and along the opposite sides of the saddle, are opposing tapered surfaces 134 that are intended to interact with tapered surfaces of an adjustable member such as an adjustment screw as depicted in FIGS. 2 and 6-7, for example. Tapered surfaces 134 are sloped from the outside toward the center of slot 118, and are preferably at an angle that interacts with the head 156 of the adjustable member 154 that is placed therein when in use.

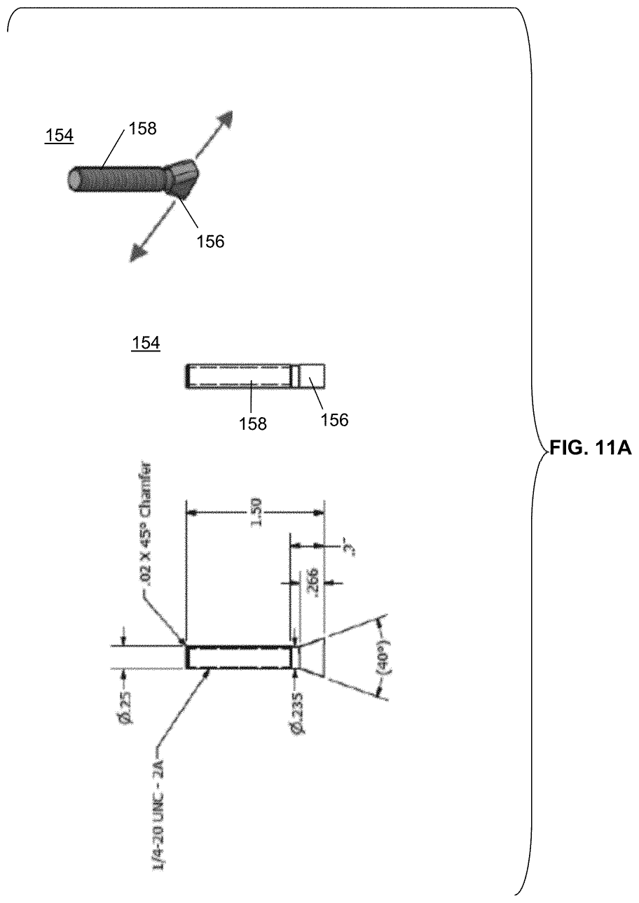

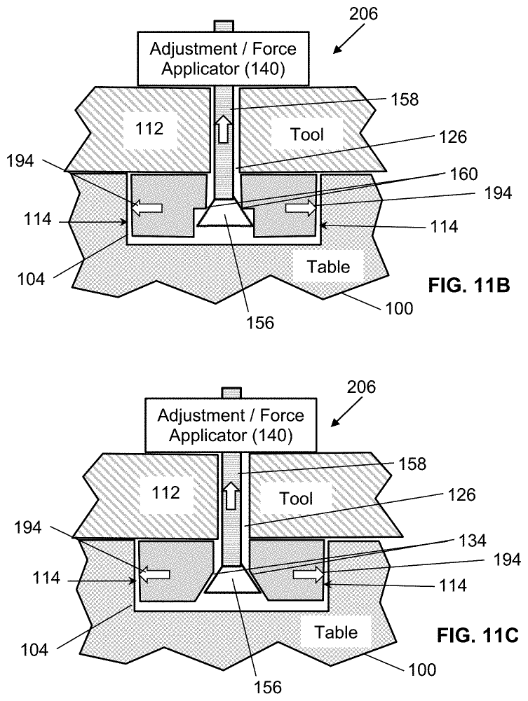

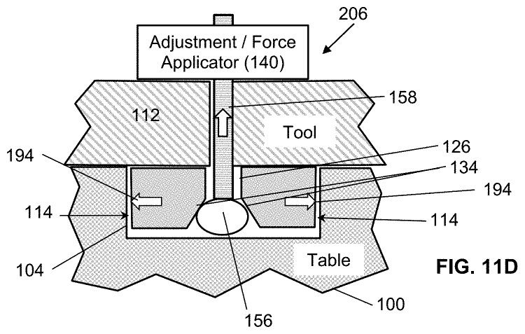

Referring also to FIGS. 2, 6-8 and 11A-11D, adjustable members 154 include heads 156 of adjustment screws 154 in accordance with one embodiment of the improved anchor bar. More specifically, anchor bar 108 is depicted in various embodiments, which may be used for releasably mounting a work tool 112 on a work surface such as a saw or drill-press table 100 having a groove 104 therein as depicted, for example, in FIGS. 8 and 11A-11D.

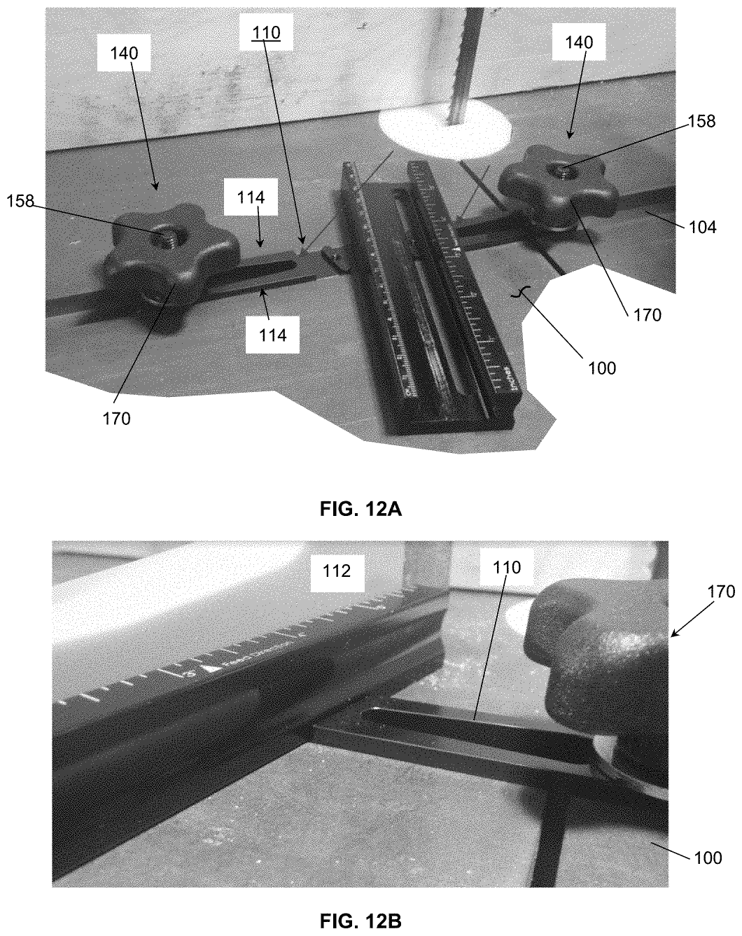

Referring next to FIGS. 3A-3C, depicted therein is another embodiment of an anchor bar 108. FIG. 3A illustrates a side perspective view while FIGS. 3B and 3C illustrate top and bottom perspective views. The embodiment depicted also includes three sections, an elongated, solid middle section 210 separating the ends 214 and 216. In this embodiment, middle section 210 is wider than in the embodiment of FIGS. 1A-1C, as it provides a rigid base for mounting of a GuidePRO™ bandsaw guide (112 in FIG. 12B). In other words, the center section 210 can be thin or narrow, or large, depending upon the use. In the use illustrated in FIG. 2, for the FEATHERPRO™ the center section primarily serves as a spacer between the end sections, whereas in the use illustrated in FIGS. 12A-12B, the center section is used for mounting of the GuidePRO. Each end (214, 216) of the anchor bar has a longitudinal slot 118 terminating in a vertical end slit 120, which splits each end of bar 108 into two attached but opposing sides.

The bar 108 also has an outer surface 124 for frictional contact with the walls of the groove or T-slot so as to hold the anchor bar in place when an adjustment member is tightened and opposing sides 114 are pushed against the groove or T-slot walls. And, the anchor bar 110 further includes internal saddle 130 between the opposing sides. The saddle is delineated or defined by a generally rectangular recess 132 spanning the opposing sides 114 and slot 118, and has a vertical aperture 126 therein. Within the saddle 130, and along the opposite sides of the saddle, are opposing tapered surfaces 134 that are intended to interact with tapered surfaces of an adjustable member such as an adjustment screw as depicted in FIGS. 2 and 6-7, for example. Tapered surfaces 134 are sloped from the outside toward the center of slot 118, and are preferably at an angle that interacts with the head 156 of the adjustable member 154 that is placed therein when in use.

The anchor bar 108 includes a longitudinal bar 110 having a generally rectangular cross-section with opposing sides 114 as well as upper and lower surfaces, the width of the longitudinal bar is almost 0.75 in., just slightly narrower than the 0.75 in. interior width of the groove, so that the bar can be placed into and slide within the groove in a relaxed state. It will be appreciated that other bar dimensions may be adjusted or modified to fit particular uses including, for example, a wider bar to fit a correspondingly wider slot. As illustrated in FIGS. 1A-3C, bar 108 includes at least one region (e.g., each end 214, 216) thereof with a slot 118 terminating in a vertical slit 120 separating the sides 114 from one another along the at least one region to allow the outward expansion of sides only, and at least one vertical aperture 126 therethrough. As will be appreciated, longitudinal bar 110 includes an elongated slot or hole 118 that is connected by slit 120 so that a significant portion of the bar (e.g., approximately 1-2 inches) is essentially split in half, and the respective sides or halves may be flexed or displaced outward relative to one another to contact the walls of the table groove in response to a separation force.

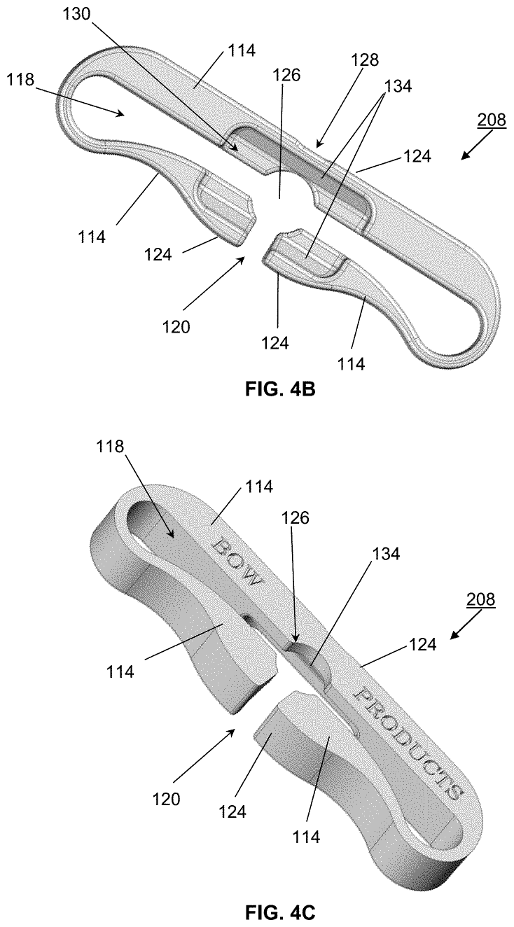

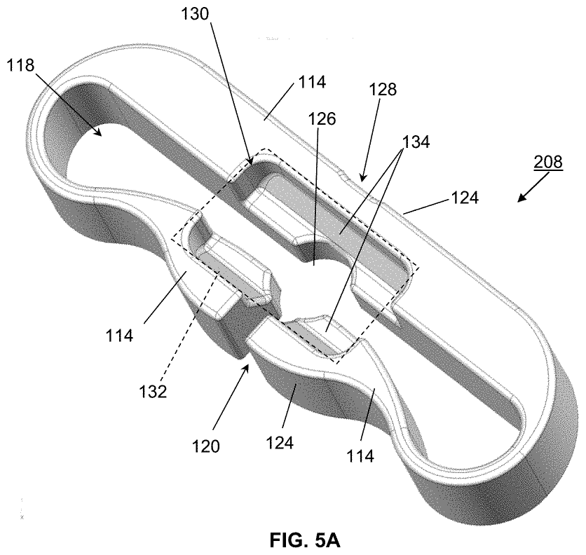

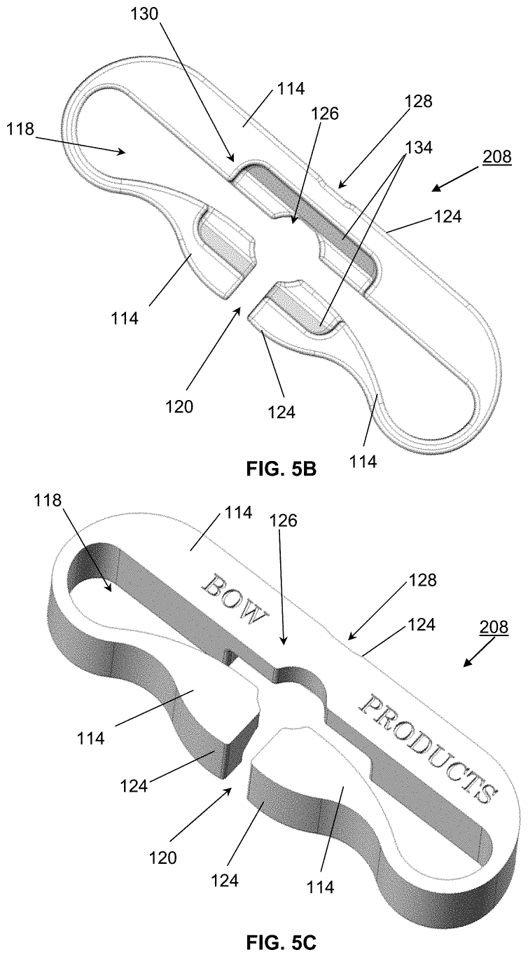

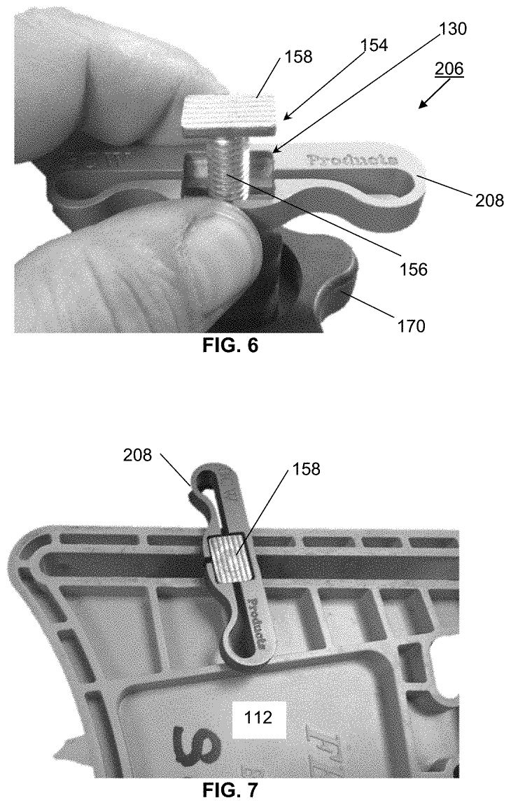

Referring to an alternative embodiment of the anchor bar 208 depicted, for example, in FIGS. 4A-4C, 5A-5C and 6-7, the anchor bar itself still includes a longitudinal bar, albeit shorter in length than the embodiments of FIGS. 1A-1C and 3A-3C. The alternative embodiment of FIGS. 4A-5C has a single longitudinal slot, where the slot splits the bar into attached but opposing sides 114. Bar 208 also has an outer surface 124 for frictional contact with the groove. As with the long bar 108, the outer contact surfaces 124 may be non-planar (e.g., radiused slightly in longitudinal direction) to assure a focused contact point or region with the interior walls of a groove. The continuous side of the short anchor bar 208 also includes a small inward arcing detent that serves a similar purpose, and further causes that side of the short bar to be placed in a slightly “bent” condition when the T-bolt is tightened to interact with the saddle. This inward arcing detent releases back to its depicted state when the force of the T-bolt is released and thereby causes the T-bolt to “release” when it is loosened, allowing the bar to return to its unflexed and non-expanded state within a groove. In use, the surfaces 124 are placed into contact by an adjustable member (not shown) acting on saddle 130. The internal saddle 130 is a generally rectangular recess 132 with a vertical aperture 126, and is located between the opposing sides 114. And, as described above, the saddle 130, includes opposite sides of the saddle with tapered surfaces 134. In the depicted embodiment, one side of the saddle 130 is split by a vertical slit 120, to permit the saddle to freely expand in response to an adjustable member placed in the saddle to apply force through the tapered surfaces 134, for example as depicted in FIGS. 6-7.

Referring also to FIGS. 6 and 7, it will be appreciated that an assembly 206 for releasably mounting a work tool on a work surface would further comprise an adjustable member 154 having a head 156 at one end of a shaft 158. As illustrated in the exemplary cross-sectional views of FIGS. 11A-11D, the head 156 of member 154 may be of various shapes, provided that the head includes a tapered or similar profile on at least opposing sides.

The adjustable member 154 is suitable for shaft 158 to be inserted through the vertical aperture 126, such that the tapered profile of head 156 aligns with the opposing tapered surfaces 134 of the saddle 130, in order for the tapered profile on opposite sides of the head to contact the opposing tapered surfaces. In such an assembly, applying a force to the assembly via tension being applied to the shaft causes, in response, an outward expansion of sides 114 so as to produce frictional interference between the opposing sides of the bar 208 and a groove or T-slot in a work table (e.g., FIGS. 11B-11D). As will be further appreciated, a force applicator 140, is removably attached to the adjustable member 154, and may be any mechanism suitable for creating a force to draw the head of the adjustable member into contact with the tapered surfaces of the saddle.

In various embodiments the force applicator may be a knob or similar mechanism having a threaded internal hole to receive a threaded shaft 158. In the alternative depicted, for example, in FIG. 14, the force applicator may be a cam-type (quick-release) mechanism. Furthermore, use of an adjustable member 154 in the form of the depicted T-bolt having a rectangular head, as depicted in FIG. 6 for example, assures that the head seats within the rectangular sides of saddle 130, which prevents the T-bolt from turning as knob 140 is tightened or loosened.

Also contemplated are alternative mechanisms that are associated with the T-bolt head 156, or the corresponding saddle 130, where a further mechanical advantage is achieved to spread the sides 114 of the anchor bar apart and increase the force applied between the anchor bar and the groove. In one embodiment, a pivoting component (e.g., roller, cam, pawl) may be added to the saddle, in addition to or as a replacement for sloped surfaces 134. The pivoting component, for example, a cam-type member would be contacted by the T-bolt head and as the T-bolt is tightened, the head would cause the cam-type member to spread the saddle open and move the sides outward. Use of a cam or similar mechanical lever may improve the amount of lateral travel and force generated in response to tension applied to the adjustable member 154 (T-bolt). It will also be appreciated that similar mechanisms to increase the mechanical advantage and travel may also be implemented on the adjustable member 154 (e.g., T-bolt) itself.

With regard to FIGS. 11A-11D, the separation force for locking the anchor bar in place may be created by an adjustable assembly 206, including a screw-like or similar member 154 having a head 156 at one end of a shaft 158. As illustrated in FIGS. 11A-11C, the head 156 has a tapered profile (flat and/or arcuate) on at least opposing sides thereof. The adjustable member 154, of assembly 206, is suitable for insertion through the at least one vertical aperture 126, such that the tapered profile of head 156 aligns with opposed interior features 134 or 160 of the saddle in order for the tapered profile on opposite sides of the head 156 to contact the opposed interior features.

As illustrated in FIGS. 11A-11D the opposed interior features 134 and 160 include corners aligned in parallel with the opposing sides as well as tapered surfaces. Alternatively, the opposed interior features 134 and 160 include curved surfaces about a plane that splits the shaft and head of the adjustable member and is perpendicular to the opposing sides of the anchor bar.

Upon tightening (pulling upward on shaft 158 of member 154), an upward force 190 is applied to the adjustable member, resulting in the outward forces 194 and expansion of sides 114 to produce frictional interference between the opposing sides 114 of the bar 110 and the interior sides or edges of the groove 104.

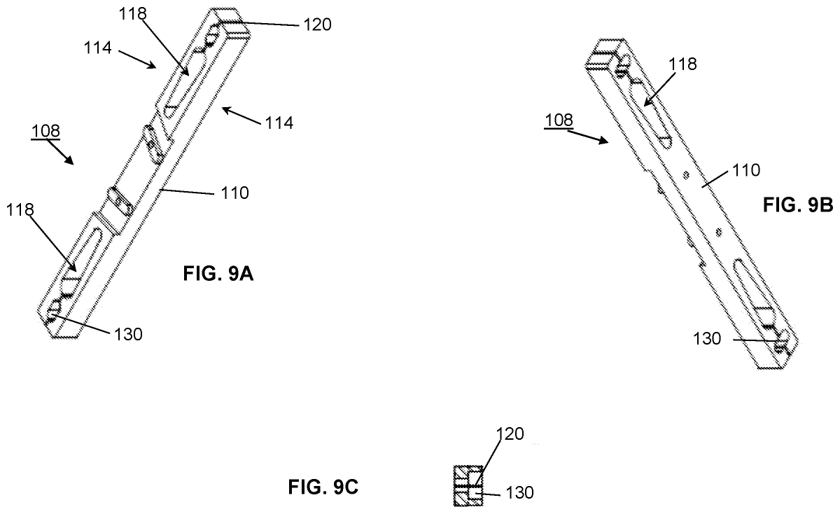

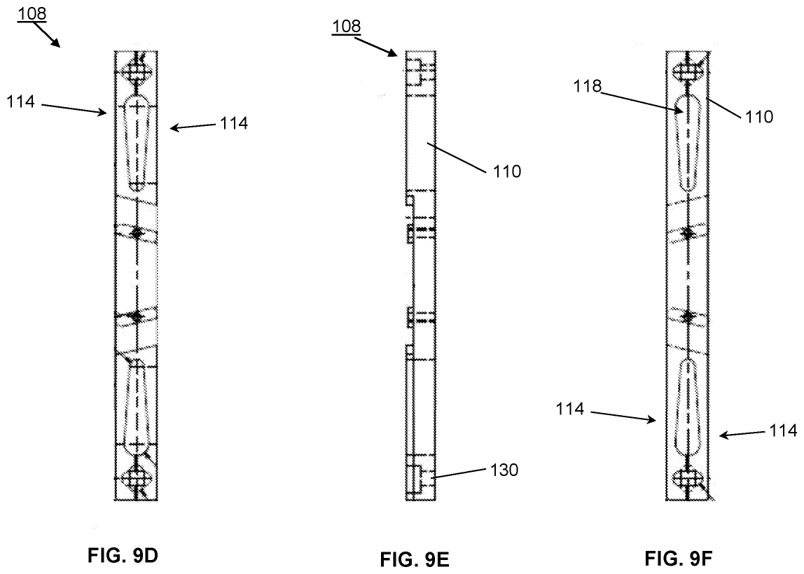

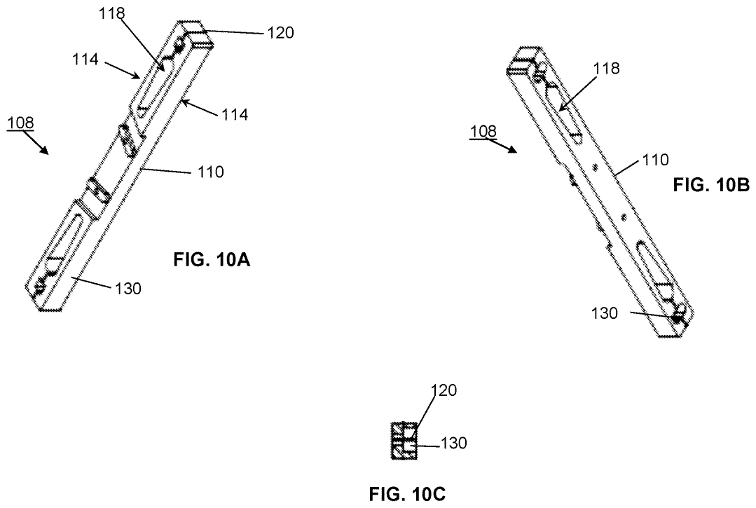

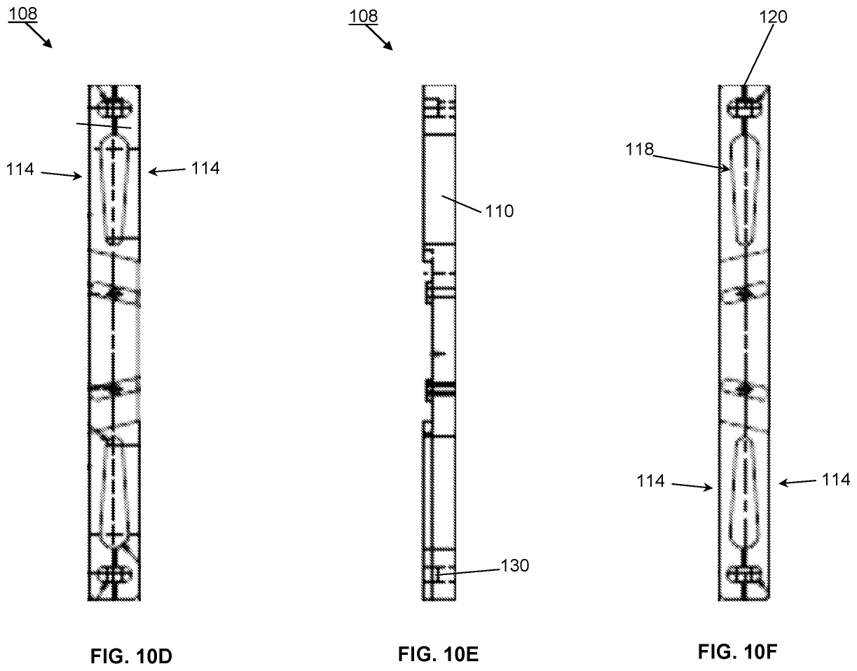

The detailed drawings of FIGS. 9A-9E and 10A-10E are illustrative examples of two alternative designs for the long anchor bar of FIGS. 3A-3C. FIGS. 9A-9E are representative drawings of a machined anchor bar produced by machining a piece of metal stock, whereas FIGS. 10A-10E are representative drawings of an anchor bar produced by die casting with a metal. While typically formed of an aluminum alloy various metals and alloys may be employed for machined or die-cast manufacture of the anchor bars. It will be appreciated that the drawings of FIGS. 9A-9E and 10A-10E present an alternative deign to that described in detail above, but continue to include several of the anchor bar features discussed herein, such as center and end sections, sides 114 along slot 118 with vertical end slit 120 at the end of the saddle 130.

As depicted in FIGS. 2 and 12A-13 the anchor bar may be assembled with any tool, guide, etc., such a FeatherPRO™ or GuidePRO™ bandsaw guide 112 to provide an anchor to the table surface 100 via groove 104. While the shaft 158 may be of any configuration, a cylindrical shaft is illustrated, and in order to use a threaded adjustment techniques, the shaft 156 may be threaded using machine threads over a portion or the entire length of the shaft. To complete the adjustable assembly 206, the shaft may be threadably attached to a force applicator such as an adjustment knob 170 or to a cam-like locking mechanism 172, for example, a quick-release cam-lock handle (available from Ostart, e.g., Bike Bicycle Quick Release Seatpost Seat Clamp).

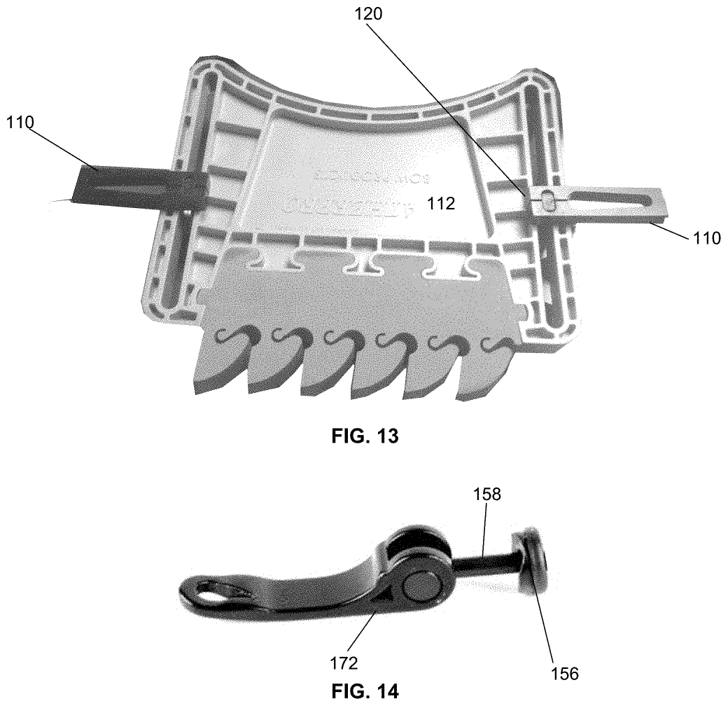

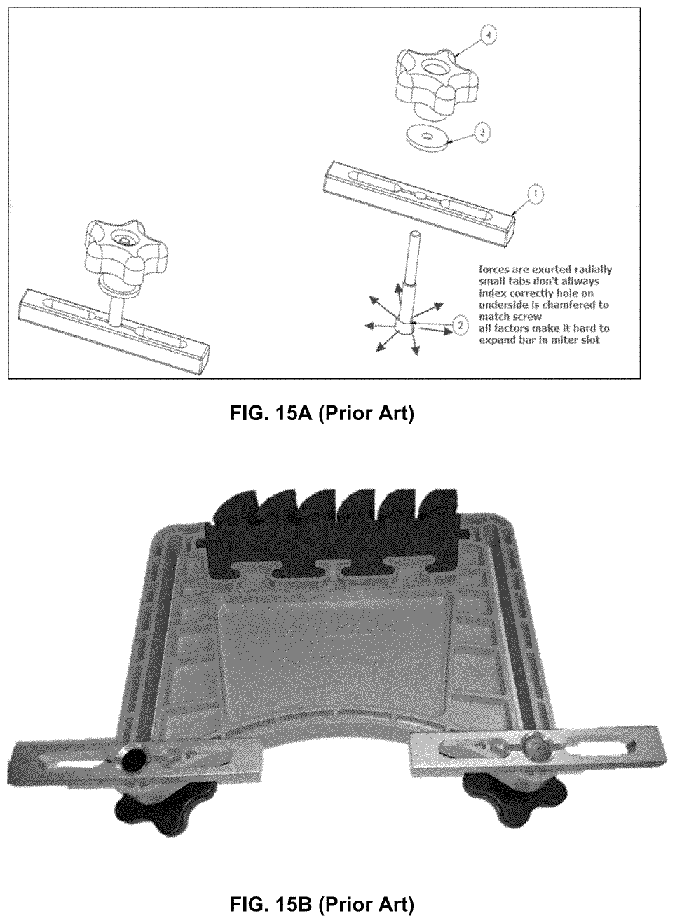

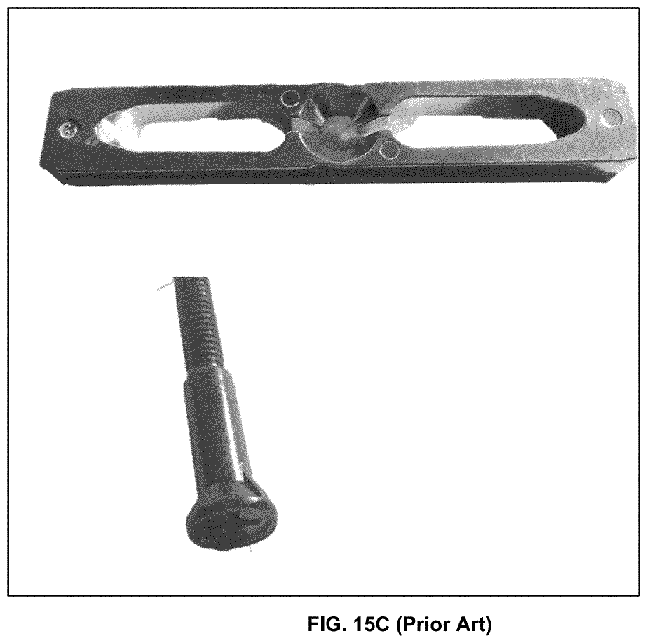

Considering FIG. 13 of the figure illustrates an alternative embodiment of the anchor bar (half-bar) 208 attached for use with a FEATHERPRO™ featherboard guide 112 by Bow Products. In the illustrated embodiment, the half-bar is similar to one of the ends of the long bar 110 in FIGS. 1A-1C, and the saddle is reduced in size.

FIG. 14 is an illustration of the alternative, cam-type mechanism for applying an upward force to the adjustable member of the anchor bar. The quick-release cam 172 can be adjusted to the situation by screwing head 156 up or down on shaft 158. Once adjusted the cam may be used to quickly fix and release the anchor bar. An example of a suitable mechanism is the Bicycle Quick Release Seatpost Seat Clamp available from Ostart Bike.

It should be understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

What is claimed is:

1. An anchor bar for releasably mounting a work tool on a work surface having a groove therein, comprising:
a longitudinal bar having a generally rectangular cross-sectional perimeter with opposing sides as well as opposing upper and lower surfaces, the width of the longitudinal bar being just slightly narrower than an interior width of the groove so that the bar can be placed into and slide within the groove in a relaxed state, said bar including at least one region thereof with a vertical slit separating the sides from one another along the at least one region to allow the outward expansion of sides only, and at least one vertical aperture therethrough; and
an adjustable member having a head at one end of a shaft, said head having a tapered profile on at least opposing sides thereof, said adjustable member being suitable for insertion through the at least one vertical aperture, such that the tapered profile aligns with opposed interior features of the vertical aperture in order for the tapered profile on opposite sides of the head to contact the opposed interior features of the aperture and cause, in response to an upward force being applied to the adjustable member, the outward expansion of sides only so as to produce frictional interference between the opposing sides of the bar and the interior of the groove.

2. The anchor bar according to claim 1, wherein said adjustable member is a screw threadably attached to adjustment knob.

3. The anchor bar according to claim 1, wherein said adjustable member is a screw-like member attached to a quick-release cam-lock handle.

4. The anchor bar according to claim 1, wherein said head has a tapered profile only on opposing sides thereof.

5. The anchor bar according to claim 1, wherein said tapered profile is arcuate.

6. The anchor bar according to claim 1, wherein the opposed interior features of the aperture include corners aligned in parallel with the opposing sides.

7. The anchor bar according to claim 1, wherein the opposed interior features of the aperture include tapered or curves surfaces about a plane that splits the shaft and head of the adjustable member and is perpendicular to the opposing sides.

8. The anchor bar according to claim 1, wherein at least a portion of the opposing sides of the bar are non-planar.

9. An anchor bar assembly for releasably mounting a work tool on a work surface having a groove therein, comprising:
a longitudinal bar having at least one longitudinal slot therein, said slot splitting the bar into two attached but opposing sides, the bar also having an outer surface for frictional contact with the groove, the bar further including an internal saddle between the opposing sides, the saddle including a generally rectangular recess and a vertical aperture therein, and where opposite sides of the saddle include opposing tapered surfaces;
an adjustable member having a head at one end of a shaft, said head having a tapered profile on at least opposing sides thereof, said adjustable member being suitable for insertion through the vertical aperture, such that the tapered profile aligns with the opposing tapered surfaces of the saddle in order for the tapered profile on opposite sides of the head to contact the opposing tapered surfaces to cause, in response to a force applied to the adjustable member, an outward expansion of the sides only so as to produce frictional interference between the opposing sides of the bar and the groove; and
a force applicator, removably attached to the adjustable member, creating a force to draw the head of the adjustable member into contact with the tapered surfaces of the saddle.

10. The anchor bar assembly according to claim 9, wherein said longitudinal bar has at least two longitudinal slots therein, each slot splitting the bar into two attached but opposing sides along the slot.

11. The anchor bar assembly according to claim 10, where said longitudinal slots are at opposite ends of the longitudinal bar.

12. The anchor bar assembly according to claim 11, where each of said longitudinal slots has a saddle and each end of the bar is split beyond the saddle, such that the adjustable member and force applicator serve to laterally separate the opposing sides, particularly at the end of the anchor bar.

13. The anchor bar assembly according to claim 9, wherein the longitudinal bar further includes a lateral slot at a midsection of the longitudinal slot, said lateral slot dividing at least one of said opposing sides into two parts.

14. The anchor bar assembly according to claim 13, wherein the saddle is positioned so as to span the lateral slot.

15. The anchor bar assembly according to claim 1, wherein at least a portion of the outward surface of the sides is non-planar and increases the frictional interference between the portion of the outward surface and the groove.
